(19) United States
(12) Patent Application Publication
(10) Pub. No.: US 2017/0297039 A1
(43) Pub. Date: Oct. 19, 2017

(54) SHOWERHEAD WITH DUAL OSCILLATING MASSAGE

(71) Applicant: Water Pik, Inc., Fort Collins, CO (US)

(72) Inventors: Joseph W. Cacka, Berthoud, CO (US); Craig P. Rogers, Fort Collins, CO (US)

(21) Appl. No.: 15/483,742

(22) Filed: Apr. 10, 2017

Related U.S. Application Data
(60) Provisional application No. 62/323,219, filed on Apr. 15, 2016.
(60) Provisional application No. 62/423,650, filed on Nov. 17, 2016.

(51) Int. Cl. B05B 1/08; B05B 1/16; B05B 1/18

(52) U.S. Cl. CPC B05B 1/083; B05B 1/185; B05B 1/1663; B05B 1/169

(57) ABSTRACT

In one embodiment, a massage mode assembly for a showerhead is disclosed. The massage mode assembly includes a drive element, a cam, and a shutter. The drive element has a drive element length or diameter, depending on the shape of the drive element, and is rotatable about an axis by fluid flowing through the showerhead. The cam is connected to the drive element and rotates with the drive element. The shutter is operably engaged with the cam and has a shutter length that is longer than the drive element length and the rotation of the cam causes the shutter to move correspondingly.

### CROSS REFERENCE TO RELATED APPLICATIONS

The present application claims priority to U.S. Provisional Application No. 62/323,219 filed in Apr. 15, 2016 entitled “Showerhead with Dual Oscillating Massage” and U.S. Provisional Application No. 62/423,650 filed Nov. 17, 2016 entitled “Showerhead with Dual Oscillating Massage,” both of which are incorporated by reference herein in their entireties. The present application is related to U.S. Pat. No. 9,404,243 entitled “Showerhead with Turbine Driven Shutter,” filed on Jun. 13, 2014 and U.S. patent application Ser. No. 15/208,158 entitled “Showerhead with Turbine Driven Shutter,” filed on Jul. 12, 2016, both of which are incorporated by reference herein in their entireties.

### TECHNICAL FIELD

The technology disclosed herein relates generally to showerheads, and more specifically to pulsating showerheads.

### BACKGROUND

Many showerheads emit pulsating streams of water in a so-called “massage” mode. Typical massage modes are achieved by rotating a shutter in a circular manner that blocks or covers nozzle apertures as it spins. Due to the circular rotation path, nozzles are opened in a sequential manner and many times a first nozzle aperture will be partially closed as the shutter rotates to close a second nozzle aperture (which will be partially open until the rotation moves the shutter further). This distributes the water across multiple nozzle outlets, reducing the force experienced by the user in the massage mode. Additionally, many massage mode nozzle outlets are arranged in a center of the showerhead and are clustered tightly together. This means that the water exiting the nozzles impacts a small surface area on the user. As such, there is need for an improved massage mode for a showerhead that increases the force experienced by a user, expands the impact area on a user's body, or both.

The information included in this Background section of the specification, including any references cited herein and any description or discussion thereof, is included for technical reference purposes only and is not to be regarded subject matter by which the scope of the invention is to be bound.

### SUMMARY

In one embodiment, a massage mode assembly for a showerhead is disclosed. The massage mode assembly includes a drive element, a cam, and a shutter. The drive element has a drive element length or diameter, depending on the shape of the drive element, and is rotatable about an axis by fluid flowing through the showerhead. The cam is connected to the drive element and rotates with the drive element. The shutter is operably engaged with the cam and has a shutter length that is longer than the drive element length and the rotation of the cam causes the shutter to move correspondingly.

In another embodiment, a showerhead for producing an oscillating pulse is disclosed. The showerhead includes a housing having an inlet in fluid communication with a fluid source and an engine received within the housing and in fluid communication with the fluid source. The engine including a turbine, a cam extend from the turbine, a shutter operably connected to the cam, a first plate in fluid communication with the inlet and a second plate in fluid communication with the inlet. The second plate includes a first group of outlet nozzles, a second group of outlet nozzles, a third group of outlet nozzles, and a fourth group of outlet nozzles. In operation, the turbine rotates as fluid flows from the inlet into the engine and as the turbine rotates, the cam rotates, moving the shutter correspondingly between a first position and a second position. In the first position of the shutter, the first group of outlet nozzles and third group of outlet nozzles are fluidly disconnected from the fluid inlet and the second group of outlet nozzles and fourth group of outlet nozzles are fluidly connected to the fluid inlet and in the second position of the shutter, the second group of outlet nozzles and the fourth group of outlet nozzles are fluidly disconnected from the fluid inlet and the first group of outlet nozzles and the third group of outlet nozzles are fluidly connected to the fluid inlet.

In yet another embodiment, a showerhead is disclosed. The showerhead includes a housing having an inlet, a faceplate connected to the housing and defining a plurality of nozzles, and a massage mode assembly received within the housing and in fluid communication with the inlet and the plurality of nozzles. The massage mode assembly includes a turbine, a cam connected to the turbine such that rotation of the turbine causes rotation of the cam, and a shutter engaged with the cam such that rotation of the cam causes the shutter to move and as the shutter moves, one or more edge flow paths around one or more edges of the shutter are defined and one or more aperture flow paths through one or more flow apertures in the shutter are defined.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1 is an isometric view of a showerhead including a massage mode assembly.

FIG. 2 is a rear isometric view of the showerhead of FIG. 1.

FIG. 3 is a front elevation view of the showerhead of FIG. 1.

FIG. 4 is a cross-section view of the showerhead of FIG. 1 taken along line 4-4 in FIG. 3.

FIG. 5 is a cross-section view of the showerhead of FIG. 1 taken along line 5-5 in FIG. 3.

FIG. 6 is a top isometric view of an engine including the massage mode assembly for the showerhead of FIG. 1.

FIG. 7 is an exploded view of the engine of FIG. 6.

FIG. 8 is a cross-section view of the engine of FIG. 6 taken along line 8-8 in FIG. 6.

FIG. 9A is a top isometric view of a mounting plate of the engine of FIG. 6.

FIG. 9B is a bottom plan view of the mounting plate of FIG. 9A.

FIG. 10A is a top plan view of a jet plate of the engine of FIG. 6.

FIG. 10B is a bottom plan view of the jet plate of FIG. 10A.

FIG. 11A is a top plan view of a face plate of the engine of FIG. 6.

FIG. 11B is a bottom plan view of the face plate of FIG. 11A.

FIG. 11C is an exploded view of an example of a face plate, cover plate, and nozzle boot.

FIG. 12A is a front elevation view of the massage mode assembly.

FIG. 12B is a bottom plan view of the massage mode assembly.

FIG. 12C is a top plan view of the massage mode assembly.

FIG. 13 is a top plan view of a shutter of the massage mode assembly.

FIG. 14A is a top plan view of a drive element of the massage mode assembly.

FIG. 14B is a bottom plan view of the drive element of FIG. 14A.

FIG. 15 is an isometric view of a mist cap for the showerhead of FIG. 1.

FIG. 16A is an enlarged cross-section view of the engine illustrating the shutter in a first position.

FIG. 16B is an isometric view of the face plate illustrating the water pattern with the shutter in the first position of FIG. 16A.

FIG. 17A is an enlarged cross-section view of the engine illustrating the shutter in a second position.

FIG. 17B is an isometric view of the face plate illustrating the water pattern with the shutter in the second position of FIG. 17A.

FIG. 18A illustrates alternative examples of the nozzle banks.

FIG. 18B illustrates another example of the nozzle outlets for the nozzle banks.

FIG. 19 illustrates another embodiment of the showerhead.

### DETAILED DESCRIPTION

This disclosure is related to a showerhead including an improved pulsating or massaging spray. The massage spray is created by a massage assembly and has an increased impact area during each pulse cycle as compared to conventional massage modes, as well as an increased impact force. Additionally, the massage spray evenly divides a flow, to separate the flow to different sections of the impact area, such that the flow impacts the separate areas at substantially the same time.

In one embodiment, the massage mode or pulsating assembly includes a drive element, such as a turbine, defining a cam surface and a shutter connected to and engaged with the cam surface. In operation, water flowing through the showerhead rotates the drive element, causing the cam surface to rotate correspondingly. The shutter, which is engaged with the cam surface, acts as a cam follower and follows the movement of the cam surface. However, the movement of the shutter is constrained in one or more directions, such that the shutter will move in a reciprocating and substantially linear manner, rather than in a rotational path. As the shutter moves to a first position, one or more nozzle apertures are blocked and one or more nozzle apertures are unblocked, allowing flow therethrough. As the shutter moves to a second position, the blocked nozzle apertures are unblocked and the unblocked nozzle apertures are blocked, changing the nozzles expelling water, varying the impact location of the water on the user.

In some embodiments, the shutter is larger in at least one dimension than the drive element. For example, in one embodiment, the shutter length is longer than a diameter of the drive element such that the perimeter of the shutter extends past the perimeter of the drive element. This allows the shutter to block nozzle apertures positioned outside of a cavity containing the drive element. This allows the massage mode apertures to be positioned farther away from a center of the showerhead or other location of the drive element, increasing a spray pattern diameter for the massage mode and thus increasing a diameter of the impact area on the user.

Additionally, the showerhead may include two sets of massage mode nozzles on either side of the drive element. In these embodiments, the shutter includes flow apertures configured to allow fluid communication from the showerhead inlet with one set of massage mode nozzles on each side of the drive element, while the body of the shutter blocks the other sets of massage mode nozzles. In this manner, in the first position of the shutter, only one set of nozzles on each side of the drive element are unblocked at a time and nozzles on the same side are not open simultaneously, distributing the pulsating spray to different areas of the showerhead.

In many embodiments the nozzle groups are arranged in pairs, with the nozzle pairs being blocked and unblocked at substantially the same time. Often, the nozzle pairs are spatially separated on opposite sides of a central showerhead axis from one another. The massage mode assembly allows the pairs to be opened and closed at substantially the same time as one another, creating a more powerful pulsating stream feel, since neither set of nozzles in the pair is partially open/partially closed when the other is fully open or closed. That is, the nozzle pairs may not include “transitional” nozzles that open and close progressively.

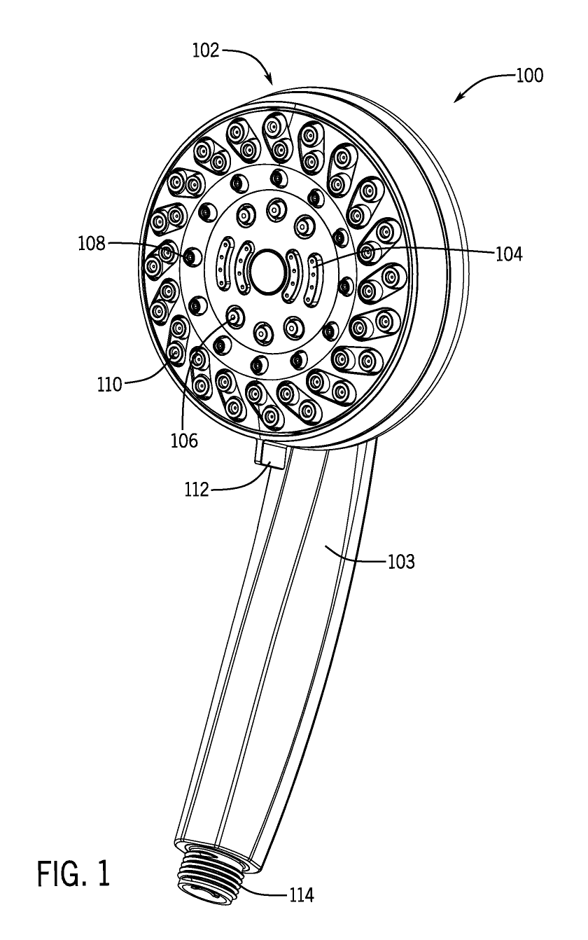

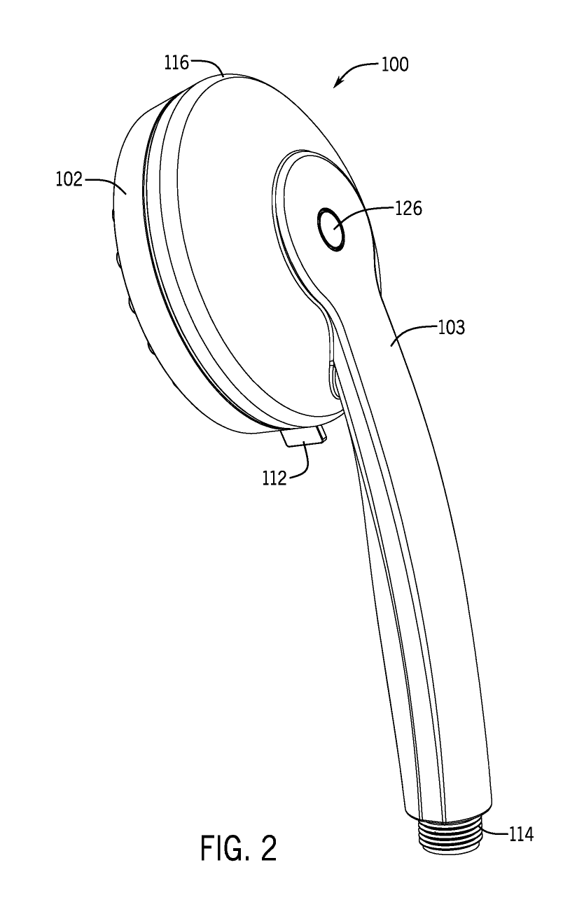

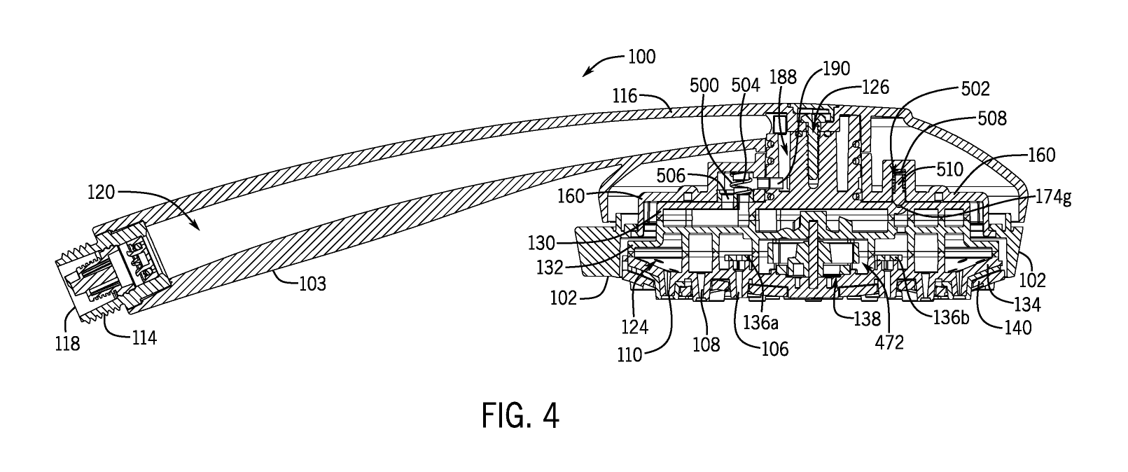

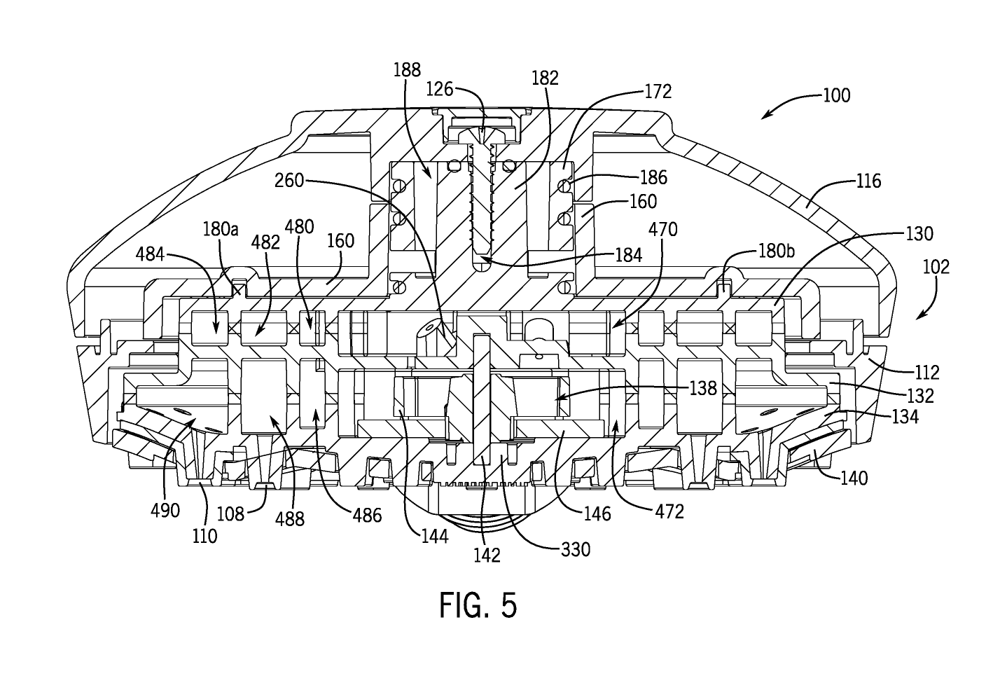

Turning to the figures, showerhead embodiments of the present disclosure will now be discussed in more detail. FIGS. 1-3 are various views of a showerhead including a massage module. FIGS. 4 and 5 are cross-sectional views of the showerhead of FIGS. 1-3. With reference to FIGS. 1-5, the showerhead 100 may include a handle 103 and a spray head 102. In the embodiment shown in FIGS. 1-5, the showerhead 100 is a handheld showerhead. However, in other embodiments the showerhead 100 may be a fixed or wall mount showerhead, in which case the handle 103 may be omitted or reduced in size. The handle 103 defines an inlet 150 that receives water from a fluid source, such as a hose, J-pipe, or the like. Depending on the water source, the handle 103 may include a connector 114, such as threading that can be used to secure the handle 103 to the hose, pipe, etc.

In embodiments where the showerhead 100 is a handheld showerhead, the handle 103 may be an elongated member configured to be comfortably held in a user's hand and define a handle passageway 120 in fluid communication with the inlet 150. Additionally, as shown in FIG. 4, the showerhead 100 may also include a flow regulator 118, a filter 121, or both that are connected to the handle 103.

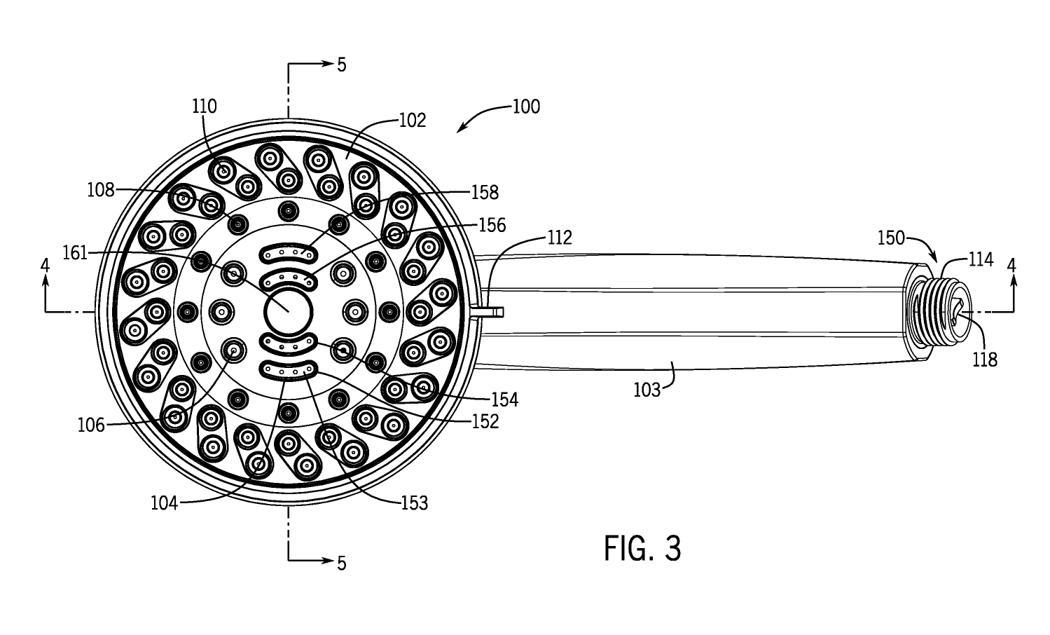

With reference to FIGS. 1 and 3, the spray head 102 includes a plurality of output nozzles arranged in sets or groups, e.g., a first nozzle group 104, a second nozzle group 106, a third nozzle group 108, and a fourth nozzle group 110, that function as outlets for the showerhead 100. In particular, each nozzle group includes a plurality of nozzles or outlets that dispense water from the showerhead. As will be discussed in more detail below, each of the selected nozzle groups 104, 106, 108, 110 may be associated with a different mode for the showerhead 100. Additionally, certain groups of nozzles, such as the first nozzle group 104 may include multiple banks of nozzles, such as a first nozzle bank 152, a second nozzle bank 154, a third nozzle bank 156, and a fourth nozzle bank 158. In one embodiment, the nozzle banks 152, 154, 156, 158 are arranged on opposite sides from one another and positioned around a central region 160 of the spray head 102. In some embodiments the first and second nozzle banks 152, 154 may be defined as crescent or curved structures defining nozzle apertures with the first nozzle bank 152 being positioned farther away from the central region 161 and generally corresponding to a curvature of the second nozzle bank 154. The third and fourth nozzle banks 156, 158 may be similarly configured. The shape and arrangement of the nozzle banks may be aesthetically pleasing to create a symmetrical arrangement. However, in other embodiments, the nozzle banks may be differently configured, e.g., straight bars, rather than curved banks, or the like. As will be discussed in more detail below, the nozzle banks 152, 154, 156, 158 may be operated in pairs, with one nozzle bank one each side of the central region being operated simultaneously and with nozzle banks on the same side being operated at different times.

In addition to varying the shape of the nozzle banks 152, 154, 156, 158, in some embodiments, the shape of the nozzle outlets within the banks may be varied. For example, as shown in FIGS. 1 and 3, each nozzle bank 152, 154, 156, 158 includes a plurality of nozzle outlets 153, in the embodiment shown in FIG. 3, there are four nozzle outlets per bank, but other variations are envisioned. In some embodiments, the nozzle outlets 153 may be shaped as circular apertures, but in other embodiments, the size, shape, and diameter of the outlets is varied. In one embodiment, each of the outlets 153 may be shaped as oblong slots that are arranged to extend parallel or perpendicular to the extension direction of the nozzle banks themselves. Similarly, in some embodiments, the nozzle outlet shape may be varied within each nozzle bank and/or different nozzle banks may have different nozzle outlet shapes.

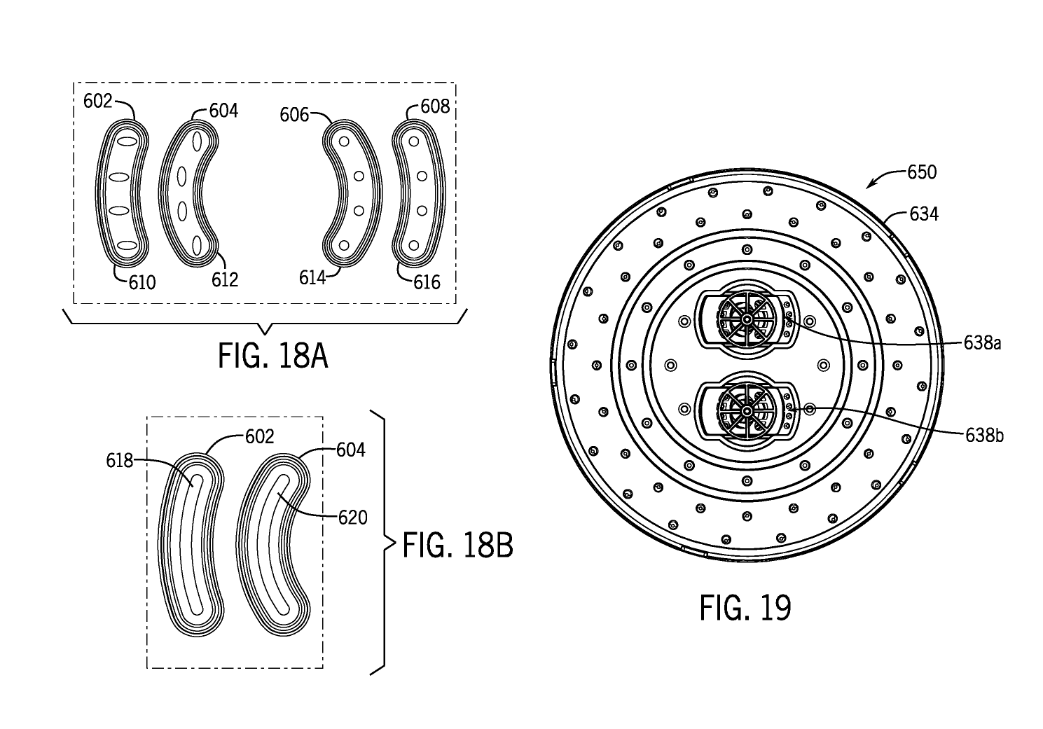

FIG. 18A illustrates a front plan view of various alternative examples of the nozzle banks. With reference to FIG. 18A, a first set of nozzle banks 602, 604 have a first type of nozzle outlet shape that varies from the nozzle outlet shape of the second set of nozzle banks 606, 608. By varying the shape of the nozzle outlets, the force experienced by the user can be varied and by selecting a first shape, size, or diameter of the nozzle outlets for a first side of the showerhead (e.g., first set of nozzle banks 602, 604) as compared to the second side (e.g., nozzle banks 606, 608), the user may experience a different force on different sides of his or her body. Similarly, within the groups of nozzle banks 602, 604, 606, 608, the nozzle outlets 610, 612, 614, 616 may be varied. In particular, the first group of nozzle banks 602, 604 have oval or slot shaped nozzle outlets 610, 612, whereas the second group of nozzle banks 606, 608 have circular nozzle outlets 614, 616. Other types of geometric or arbitrary shapes may be selected as well.

As shown in FIG. 18A, in the first nozzle bank group 602, 604, the first nozzle bank 602 includes slot or oval shaped nozzle outlets 610 that have a length perpendicular to a longitudinal length of the nozzle bank 602 (e.g., have a longer length in the direction of the shorter length of the nozzle bank). On the other hand, the second nozzle bank 604, has slot or oval shaped nozzle outlets 612 that have a length extending parallel to a length of the nozzle bank (e.g., a longer length in the direction of the longer length of the nozzle bank). This varying orientation will create a different feel for the user for each of the different banks. In addition to changing the shape or size of the nozzle outlets, the nozzle banks may have differing number of outlets in order to generate varying sensations on the user. For example, fewer nozzle outlets may generate a stronger force and so if one or more of the nozzle banks have fewer outlets, this could create an alternating light/strong sensation on the user.

FIG. 18B illustrates another example of the nozzle outlets for the nozzle banks. As shown in FIG. 18B, in some embodiments, the multiple nozzle outlets may be replaced by a single outlet, such as the nozzle outlets 618, 620. In this example, the slot or oval shaped nozzle outlet 618, 620 extends substantially the entire length of the nozzle banks 602, 604 and may be used to generate a fan shaped spray when fluidly connected to the fluid source. It should be noted that although the nozzle banks 602, 604 are shown as being arranged in an arc, in other embodiments, the nozzle banks 602, 604 may be arranged in a straight line or other configuration and the nozzle outlet shape may vary based on the shape of the nozzle bank, such that the nozzle outlets 618, 620 may track or correspond to the shape of the nozzle bank.

With reference again to FIGS. 1-5, the showerhead mode is varied by rotating the mode selector 112, which in turn rotates a back cover 160 received within the spray head 102, moving an sealing or mode selector assembly 500 to different positions relative to an engine 124. The engine 124 defines the different flow paths for the showerhead and is connected by a connection assembly 126 to the spray head 102. Other types of mode selectors may be used, such as a fixed spray head with a movable mode ring, a rotating spray head, switch or button, or the like.

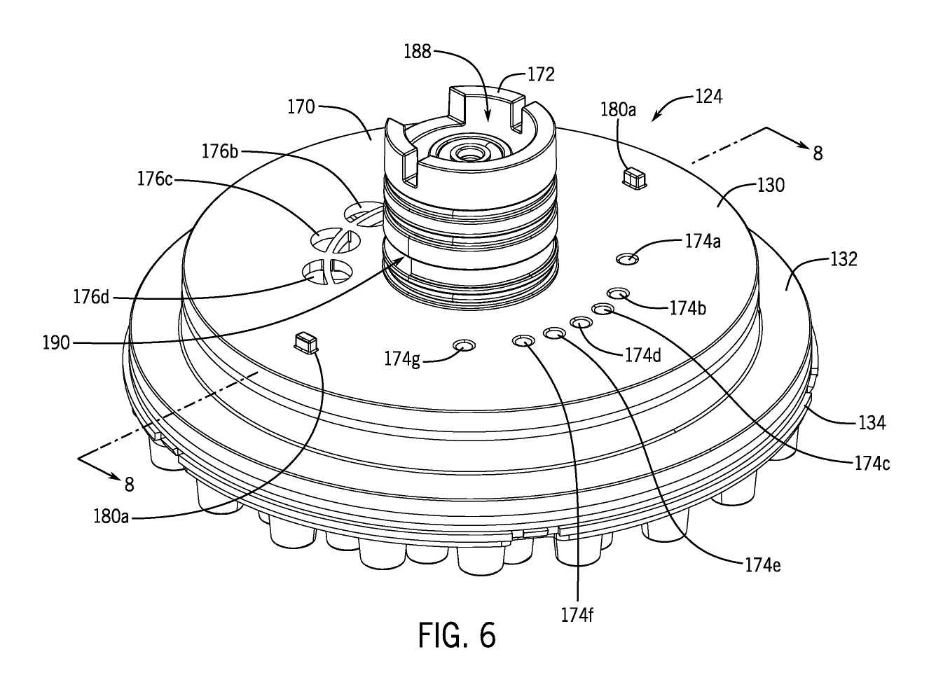

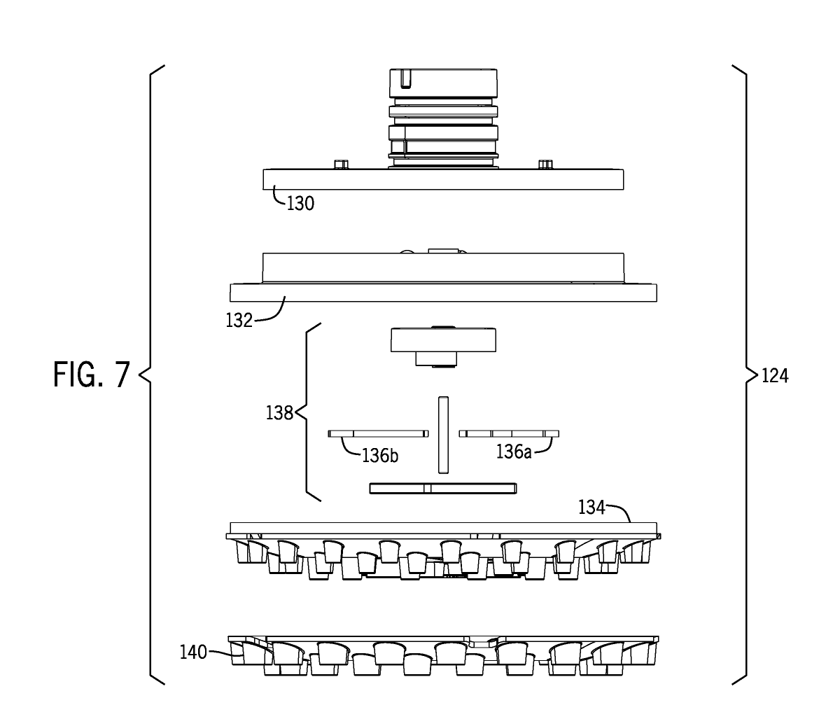

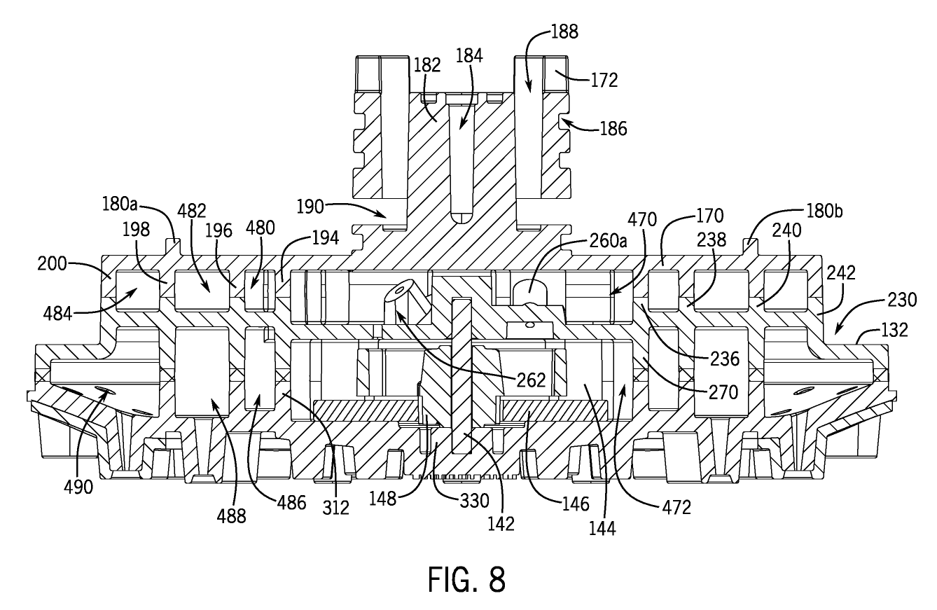

The engine 124 determines the flow characteristics of the different modes for the showerhead. The engine 124 typically includes flow control plates or levels that direct flow from the inlet 150 to different nozzle groups 104, 106, 108, 110. FIG. 6 is a top isometric view of the engine 124. FIG. 7 is an exploded view of the engine. FIG. 8 is a cross-sectional view of the engine 124 taken along line 8-8 in FIG. 6. With reference to FIGS. 6-8, the engine 124 includes a mounting plate 130, one or more jet or flow control plates 132, a face plate 134, a nozzle boot 140, a massage assembly 138, and optionally one or more mist caps 136a, 136b. The various plates and components are secured together and define multiple flow paths for water as it flows from the inlet to exit out of the nozzle groups 104, 106, 108, 110. The type, shape, and connection of the flow plates may be varied based on the type of showerhead and desired spray patterns.

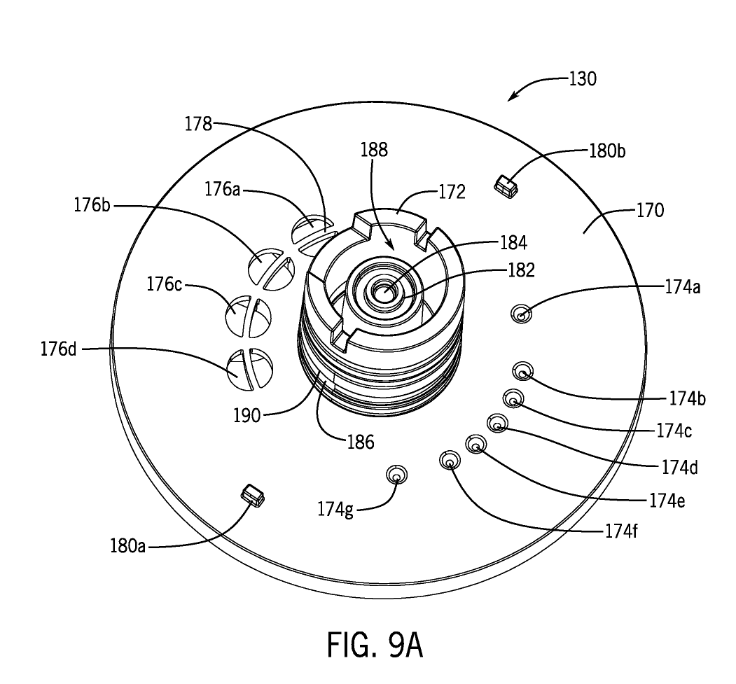

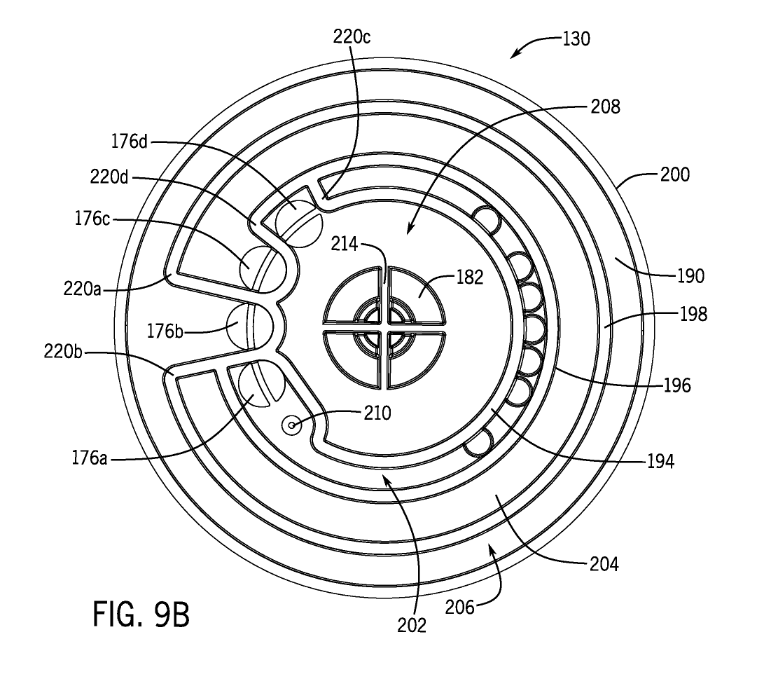

The mounting plate 130 or back plate will now be discussed in more detail. FIGS. 9A and 9B illustrate the mounting plate 130. With reference to FIGS. 8-9B, the mounting plate 130 may be a generally circularly shaped plate having a top surface 170 and bottom surface 192. An engine inlet 172 may be formed as a circular wall that extends upwards from the top surface 170 and defines an inlet lumen 188 through a portion of the engine inlet 172 (e.g., the lumen may extend along a length of the inlet 172, but a bottom wall may seal the bottom of the inlet from the interior of the mounting plate). The engine inlet 172 may include connection features, such as cutouts, tabs, or the like, that engage with corresponding structures in the housing or cover 160 to connect the mounting plate 130 to the back cover 160 or housing 116. The engine inlet 172 also may include one or more sealing grooves 186 that extend around the outer surface thereof. The sealing grooves 186 are configured to receive a sealing member, such as an O-ring, to seal the engine inlet 172 against the housing of the handle 103.

A connection shaft 182 is concentric with the engine inlet 172 and is formed within the inlet 172 such that the inlet lumen 188 is defined between the connection shaft 182 and the interior walls of the inlet 172. The connection shaft 182 may include a connection aperture 184 for engaging with a connection assembly 126 for securing the engine 124 to the housing.

With reference to FIG. 8, a plate outlet 190 is defined through an outer wall of the engine inlet 172 and is fluidly connected to the inlet lumen 188. The plate outlet 190 is fluidly coupled to a plurality of mode apertures 176a, 176b, 176c, 176d that are defined through the top surface 170 of the mounting plate 130. As will be discussed in more detail below, each of the mode apertures 176a, 176b, 167c, 176d correspond to different flow pathways within the engine 124 and thus different nozzle groups 104, 106, 108, 110 on spray head 102. Additionally, in some embodiments, each of the mode apertures 176a, 176b, 176c, 176d may include a support rib 178 that spans across the width of the aperture. The support rib 178 is used to support a sealing member that prevents water from flowing into the other mode apertures 176a, 176b, 176c, 176d when a particular mode aperture is selected.

The mounting plate 130 may also include a plurality of detent recesses 174a, 174b, 174c, 174d, 174e, 174f, 174g, defined on the top surface 170. The detent recesses 174a, 174b, 174c, 174d, 174e, 174f, 174g are used to provide feedback to a user when the engine 124 has been positioned to select a particular mode, as well as to provide some resistance to hold the engine 124 in position during operation.

Tabs 180a, 180b may also be defined on the top surface 170 of the mounting plate 130. The tabs 180a, 180b may be used to engage with a corresponding feature, such as a groove, or the like, on the back cover 160 or the interior of the housing. Additionally or alternatively the tabs 180a, 180b may act as rotational stops during mode change of the showerhead.

With reference to FIGS. 8 and 9B, the mounting plate 130 may also be used as a flow directing plate for directing water flow from the inlet to different nozzle groups. In these embodiments, the mounting plate 130 includes a plurality of channels defined by channel walls. For example, a massage channel 208 is defined by the bottom surface 192 and a first channel wall 194. The first channel wall 194 may be substantially circular and be formed on an interior of the bottom surface 192 near a central region of the mounting plate 130. A first mode channel 202 is defined between the first channel wall 194 and a second channel wall 196 that is partially parallel or concentric to the first channel wall 194. A second mode channel 204 is defined by the second channel wall 196 and a third channel wall 198. As with the other channels, the third channel wall 198 extends parallel to the second channel wall 196 for a substantial length. A third mode channel 206 is defined by the third channel wall 198 and a fourth channel wall 200, which also forms an outer wall for the mounting plate 130. Each of the channel walls, except the fourth channel wall 200, may include an end wall 220a, 220b, 220d, 220c that extends between adjacent walls. The end walls 220a, 220b, 220c, 220d define an end of the channels and also prevent fluid flowing in one channel from entering into one of the other channels.

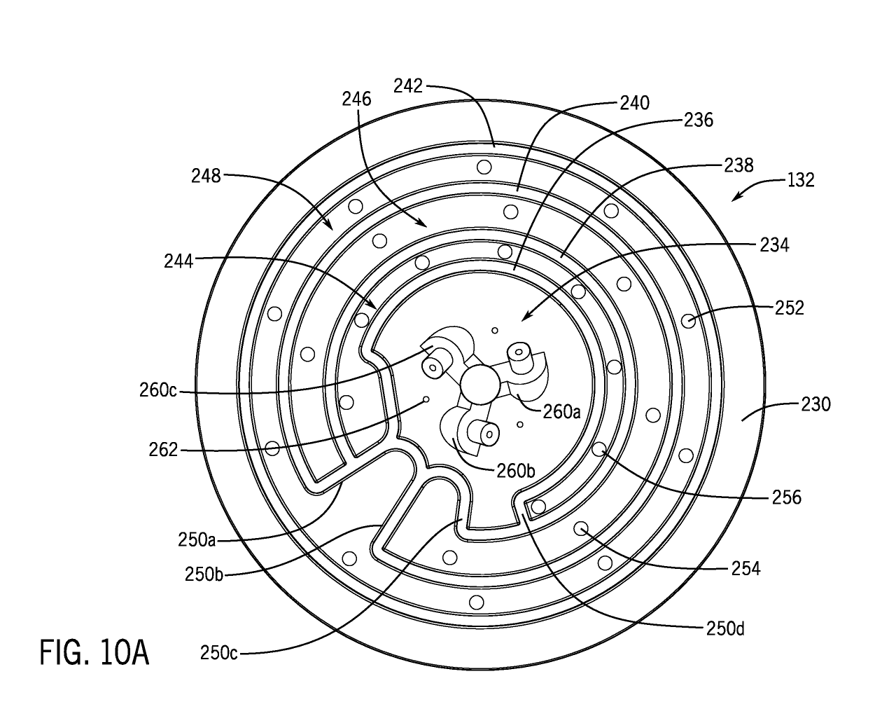

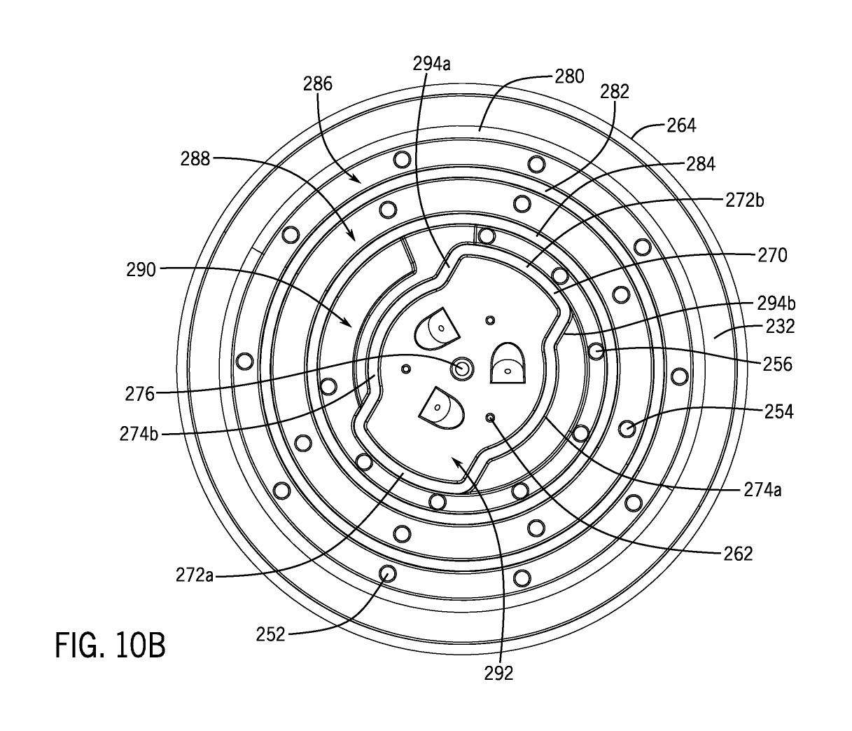

FIGS. 10A and 10B illustrate various views of the jet plate 132. The jet plate 132 combines with the mounting plate 130 to define fluid flow pathways through the engine 124. The jet plate 132 integrates jets for activating the massage mode assembly 138 with a flow directing plate, reducing the number of separate components for the showerhead 100. Similar to the mounting plate 130, the jet plate 132 includes a number of walls that engage with corresponding walls on the mounting plate 130 to create the flow pathways. With reference to FIGS. 10A and 10B, the jet plate 132 may be a generally circular plate that includes walls that extend from a top surface 230 and a bottom surface 232 such that the surfaces 230, 232 form a middle section of the jet plate 132 and the walls extend from either side.

With reference to FIG. 10A, the top surface 230 includes a first mode wall 236 that is generally circular and forms on an inner portion of the surface 230 towards a center area of the jet plate 132. The first mode wall 236 encircles a jet structure including a plurality of jets 260a, 260b, 260c that are connected to and defined in the central region of the jet plate 132. The first mode wall 236 defines a massage channel 234 encompassing the jets 260a, 260b, 260c. A plurality of disrupter jets 262 is defined through the top surface 230 in the massage channel 234.

A second mode wall 238 is defined adjacent to but separated from the first mode wall 236. The second mode wall 238 may be generally concentric to the first mode wall 236 and the first and second walls 236, 238 together define a first mode channel 244. A plurality of first mode apertures 256 are defined through the top surface 230 and spaced along the first mode channel 244. A third mode wall 240 is defined adjacent to but spaced apart from the second mode wall 238. The third mode wall 240 is radially farther from a center of the plate 132 and is substantially concentric with the second mode wall 238. The second mode wall 238 and the third mode wall 240 together define a second mode channel 246 that includes a plurality of second mode apertures 254 defined through the top surface 230 of the plate 132.

A fourth mode wall 242 is adjacent to the third mode wall 240 and positioned towards a perimeter of the jet plate 132. The fourth mode wall 242 encircles the other walls and the combination of the fourth mode wall 242 and the third mode wall 240 defines a third mode channel 248 having a plurality of third mode apertures 252 defined through the top surface 230.

With reference to FIG. 10B, a plurality of channel defining walls extend from a bottom surface 232 of the jet plate 132. An outer lip or outer wall 264 extends around the perimeter of the plate 132. A fourth mode wall 280 is concentric with but spaced radially inwards from the outer wall 264. Similarly, third and second mode walls 282, 284 are concentric with the fourth mode wall 280 but each is positioned radially inwards relative to the adjacent wall. The combination of the walls defines different mode channels that deliver fluid to select groups of nozzles. The fourth mode wall 280 and the third mode wall 282 together define the third mode channel 286 that is in fluid communication with the flow apertures 252. The third mode wall 282 and the second mode wall 284 together define the second mode channel 288 that is in fluid communication with second mode apertures 254. The second mode wall 284 and a massage mode wall 270 define the first mode channel 290 that is in fluid communication with the flow apertures 256.

With continued reference to FIG. 10B, the jet plate 132 defines a massage chamber 292 for receiving components of the massage assembly 138. The chamber 292 is defined by a massage mode wall 270 or track that includes two end walls 272a, 272b and two sidewalls 274a, 274b. In one embodiment, the end walls 272a, 272b form bumpers for the shutter 146 as discussed in more detail below. In these embodiments, the end walls 272a, 272b may be shaped as brackets and have a slightly curved shape. The curvature of the end walls 272a, 272b may be selected to match a sidewall curvature of the shutter 146 for the massage assembly 138. The sidewalls 274a, 274b include restraining segments 294a, 294b that are straight walls that transition to form the end walls 272a, 273b. The restraining segments 294a, 294b restrain movement of the massage assembly and define the movement path of the shutter. A middle section of the sidewalls 274a, 274b may be curved and extend outwards from a center of the jet plate 132. For example, the middle section of the sidewalls 274a, 274b may be convexly curved and configured to receive a drive element of the massage assembly 138. A pin recess 276 may be defined in a center of the massage chamber 292 and configured to receive and secure portions of the massage assembly.

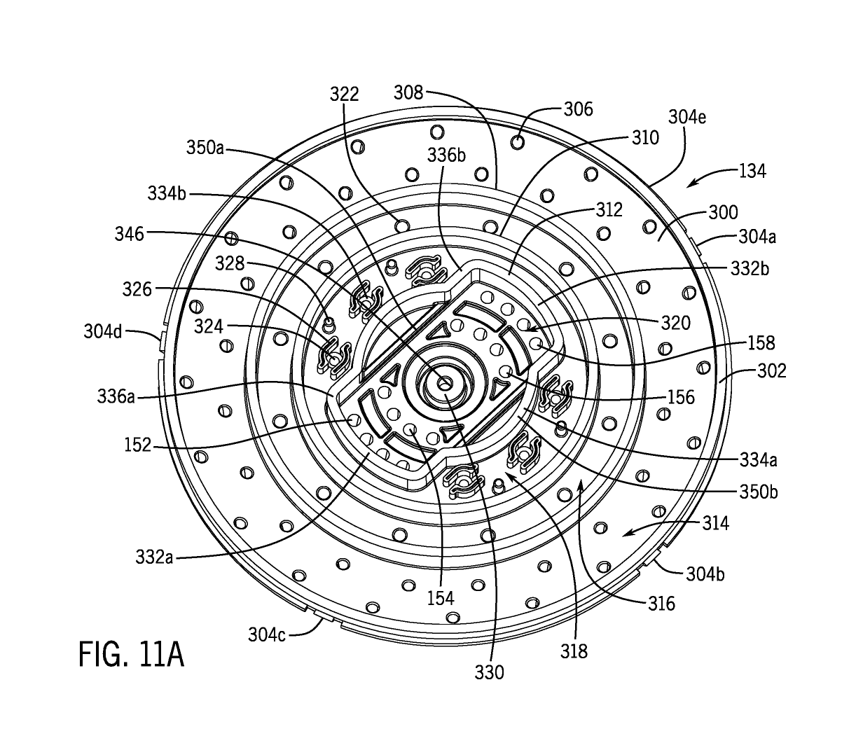

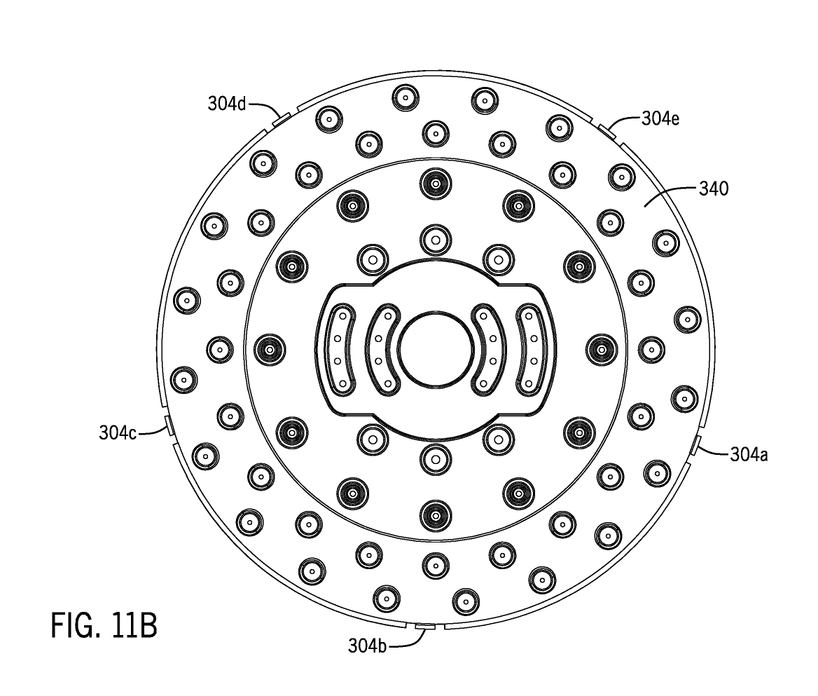

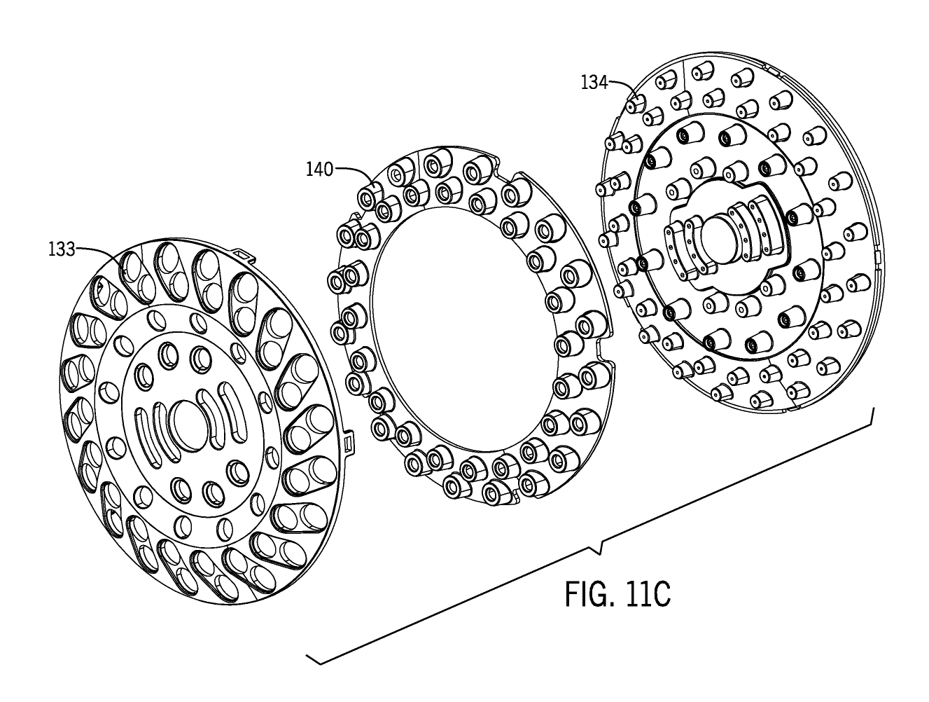

The face plate 134 or nozzle plate will now be discussed in more detail. FIGS. 11A and 11B illustrate top and bottom views of the face plate 134. The face plate 134 defines apertures that form the various nozzle groups for the spray head 102 of the showerhead 100. With reference to FIG. 11A, the face plate 134 includes an interior surface 300 having a plurality of mode walls that extend upwards from the interior surface to define a plurality of mode channels. A fourth mode or outer wall 302 extends around the perimeter of the interior surface 300 and forms the outer wall for the face plate 134. A third mode wall 308 is concentric to and positioned radially closer to a center of the face plate 134 from the fourth wall 302. A third mode channel 314 is defined between the third mode wall 308 and the fourth mode wall 302. A second mode wall 310 may be concentric with the third mode wall 308 and with the third mode wall 308 define a second mode channel 316. A first mode channel 318 defined by the second mode wall 310 and the massage wall 312. Each of the mode channels 314, 316, 318 include a plurality of mode apertures 306, 322, 324 that are fluidly connected to and define the different nozzle groups 104, 106, and 108.

In one embodiment, the mode apertures 324 in the first mode channel 318 may be mist apertures and include a mist structure 326 extending from the interior surface 300 that substantially surrounds each of the apertures 324. The mist structures 326 engage with a mist cap 136a, 136b to create a mist output from the face plate 134. In some embodiments, one or more posts 328 are defined in the first mode channel 318 to support a mist cap 136a, 136b over the mist structures 326, discussed in more detail below.

With reference to FIG. 11A, the massage wall 312 extends from the interior surface 300 and is positioned around a central region of the face plate 134. The massage wall 312 is configured to engage with the massage wall 270 of the jet plate 132 and may be shaped correspondingly. In particular, the massage wall 312 includes two end walls 332a, 332b that function as bumpers for the massage assembly 138 and that may have a slightly convex curve that extends outwards away from a center axis of the face plate 134. Connected to and extending from the end walls 322a, 322b, the wall 3212 includes restraining segments 336a, 336b that define and constrain the movement of the shutter. Finally, a middle section of the sidewalls 334a, 344b include a convexly curved portion that extends outwards away from the center axis of the face plate 134. In some embodiments, the convex portion of the sidewalls 334a, 334b has an increased curvature radius as compared the curvature of the end walls. In some embodiments, restraining shelves 350a, 350b extend upwards from the interior surface 300 and are positioned within the curved sections of the sidewalls 334a, 3344b. An interior edge of the restraining shelves 350a, 350b are aligned with the restraining segments 336a, 336b of the massage wall 312 and together with the restraining segments 336a, 366b define a movement track for the shutter as discussed in more detail below. The top surface of the shelves 250a, 250b acts to support select components of the massage assembly 138 as discussed in more detail below. The face plate 134 also includes a pin structure 330 including a pin aperture 346 for receiving.

With reference to FIGS. 11A and 11B, the face plate 134 also includes retaining features 304a, 304b, 304c, 304d, 304e that may be spaced around an outer periphery. The retaining features 340a, 304b, 304c, 304d, 304e are used to a face cover to the face plate 134. In one embodiment the retaining features 304a, 304b, 304c, 304d, 304e are tabs that expand to insert into corresponding features on the nozzle boot 140. As shown in FIG. 11C, in some embodiments, the face plate 134 may include or be connected to a face cover 133 and the nozzle boot 140. The face cover 133 provides an aesthetically pleasing appearance for the showerhead, as well as helps to define the nozzles. In other embodiments, the face cover may be omitted or combined integrally with the face plate 134.

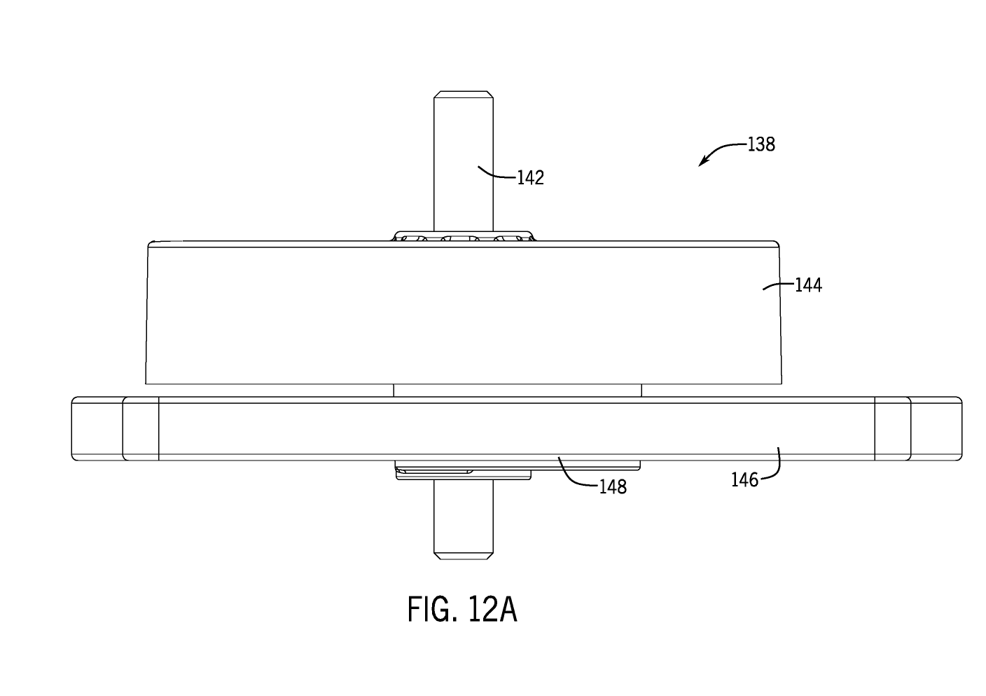

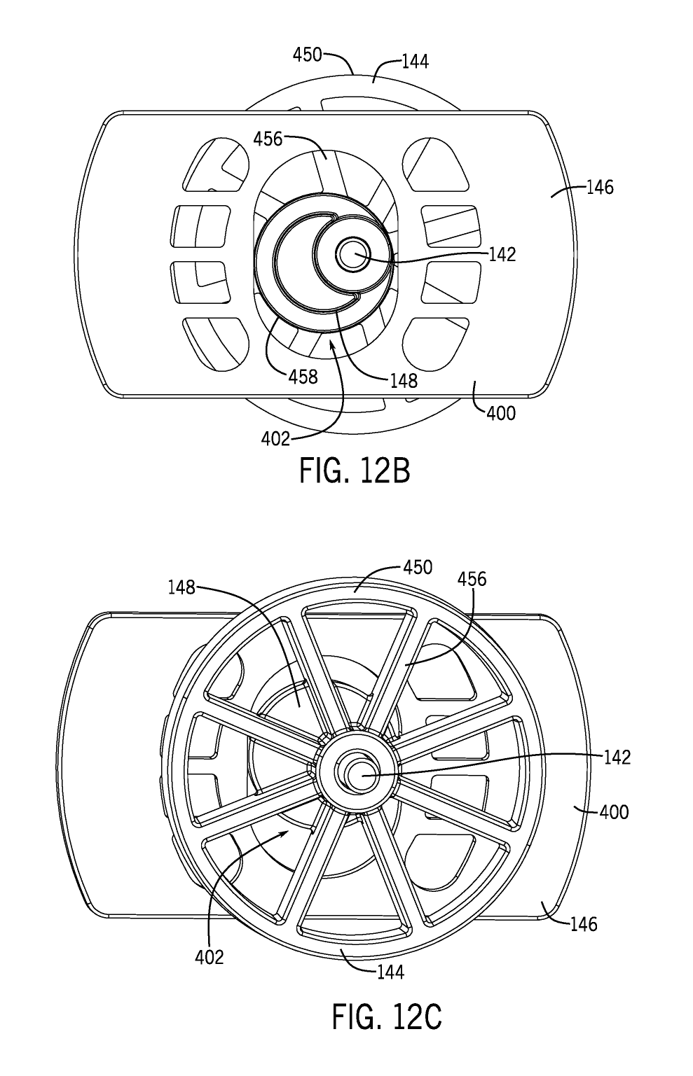

The massage assembly 138 will now be discussed in more detail. FIGS. 12A-12C illustrate various views of the massage assembly 138. The massage assembly 138 includes a securing shaft 142, a drive element 144, a cam 148, and a shutter 146 operably connected together. The shaft 142 may be a pin or other rigid member that defines a rotation axis for the drive element 144.

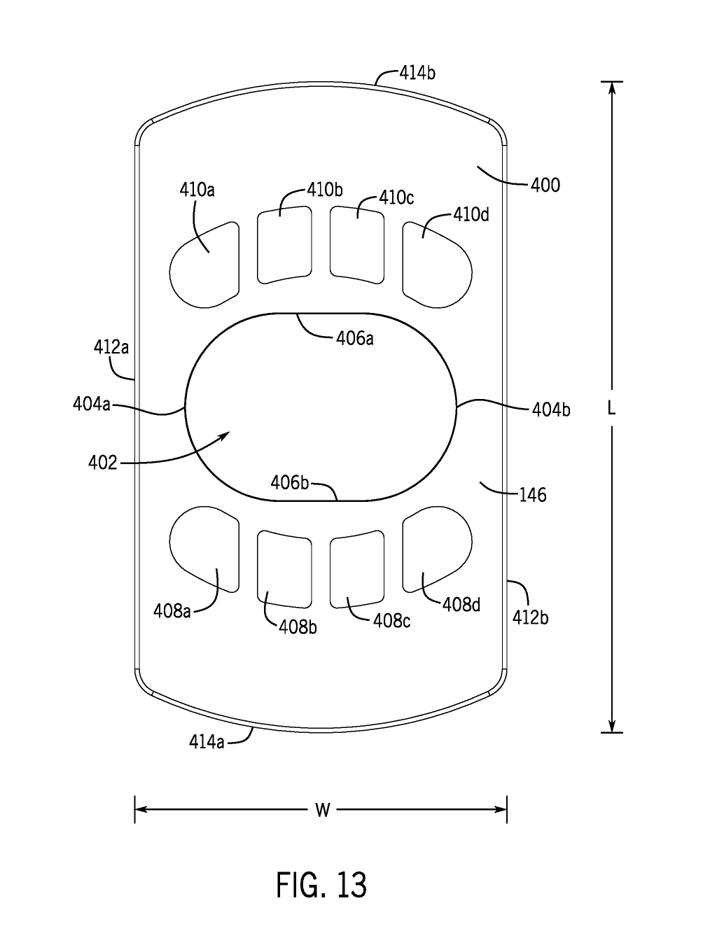

The shutter 146 defines a blocking body driven to selectively cover and uncover groups of nozzle apertures. FIG. 13 is a top plan view of the shutter 146. With reference to FIGS. 12A and 13, the shutter 146 includes a main body 400 having a length L and a width W. The length L is selected to be larger than a maximum diameter of the drive element 144, which allows nozzle apertures on either side of the drive element 144 to be closed simultaneously.

Two side or engagement edges 412a, 412b and two end or bumper edges 414a, 414b define the longitudinal and latitudinal lengths of the shutter, respectively. In some embodiments, the engagement edges 412a, 412b are straight parallel edges and the bumper edges 414a, 414b are slightly curved edges that extend between the two engagement edges 412a, 412b. The curvature and shape of the engagement and bumper edges 412a, 412b, 414a, 414b is selected based on the configuration of the massage mode chamber and walls in the jet plate 132 and face plate 134 and may be modified as desired. The engagement and bumper edges 412a, 412b, 414a, 414b may each have a consistent thickness that defines a height of the shutter 146.

A cam aperture 402 is defined through a central region of the shutter body 400. The cam aperture 402 is shaped to engage with the drive element 144 and produce an oscillating movement. In some embodiments, the cam aperture 402 is generally oval shaped oriented across a width of the shutter body 400, e.g., the maximum radius of the oval shape extends along the width of the shutter body 400 rather than the length. In some embodiments, the top and bottom walls 404a, 404b defining the top and bottom ends, respectively, of the cam aperture 402 may be curved whereas the sidewalls 406a, 406b defining the sides of the cam aperture 402 may be somewhat straight or have a reduced curvature as compared to the top and bottom walls 404a, 404b.

The shutter 146 also includes a plurality of flow apertures 408, 410 or flow windows defined through the body 400. The flow apertures 408, 410 are spaced apart from the bumper edges 414a, 414b and arranged around the edges 406a, 406b of the cam aperture 402. In some embodiments, the a first set of flow apertures 408a, 408b, 408c, 408d are arranged along a curved path on a first side of the cam aperture 402 and a second set of flow apertures 410a, 410b, 410c, 410d are defined along a curved path adjacent the second side of the cam aperture 402. Each of the flow apertures 408a, 408b, 408c, 408d, 410a, 410b, 410c, 410d may be similarly shaped or may be different from one another. In some embodiments, flow apertures on adjacent sides of the cam aperture 402 may be formed as mirror images of the opposite side. For example, in embodiments where the flow apertures extend in a curved manner, the leading edge of the arc is selected to ensure that the outlet nozzles open simultaneously with the end of the shutter opening the outboard bank of the nozzles. In other words, the arc radius, as well as the diameter of the flow apertures, is selected such that the nozzles aligning with the flow apertures are opened at the same time as the end of the shutter uncovers a second set of nozzles as described in more detail below.

In some embodiments, the flow apertures may be defined as a singular slot or opening on either side of the cam aperture. However, in embodiments where the opening includes ribs to define discrete flow apertures, the ribs help to keep the shutter substantially flat while it is moving and help to prevent the shutter from catching on the internal features of the face plate while it is oscillating.

The drive element 144 will now be discussed in more detail. FIGS. 14A and 14B illustrate top and bottom isometric views of the drive element 144. The drive element 144 drives the shutter 146 and is powered by water from the inlet 150. The drive element 144 may be configured in a number of different manners, but in one embodiment may be formed as a turbine having a center shaft 452 with a plurality of blades 456 extending radially outward therefrom, and a rim 450 connecting the blades 456 and defining the outer surface of the drive element 144. In some embodiments, the blades 456 are defined as fins that are spatially separated from one another such that fluid can flow between the blades 456, but still impact the blades 456 to rotate the drive element 144. In some embodiments, the drive element 144 is formed as a generally circular structure including a diameter D defining the width of the drive element 144. However, in other embodiments the drive element 144 may be non-circular shaped and may have a length and width. A pin recess 454 is defined through a center of the center shaft 452 and extends through the length of the shaft 452.

With reference to FIG. 14B, a cam surface 458 is defined as a circular eccentric member extending from the center shaft 452. The cam surface 458 may be defined on the bottom of the drive element 144, positioned beneath the blades 456 and outer rim 450. The cam surface 458 terminates before the bottom edge of the center shaft 452 and has a center axis offset from a center axis of the center shaft 452. In this manner, the center axis of the cam surface 458 is offset from a center axis of the outer rim 450 and is configured to define an oscillating motion for the shutter 146, as discussed in more detail below.

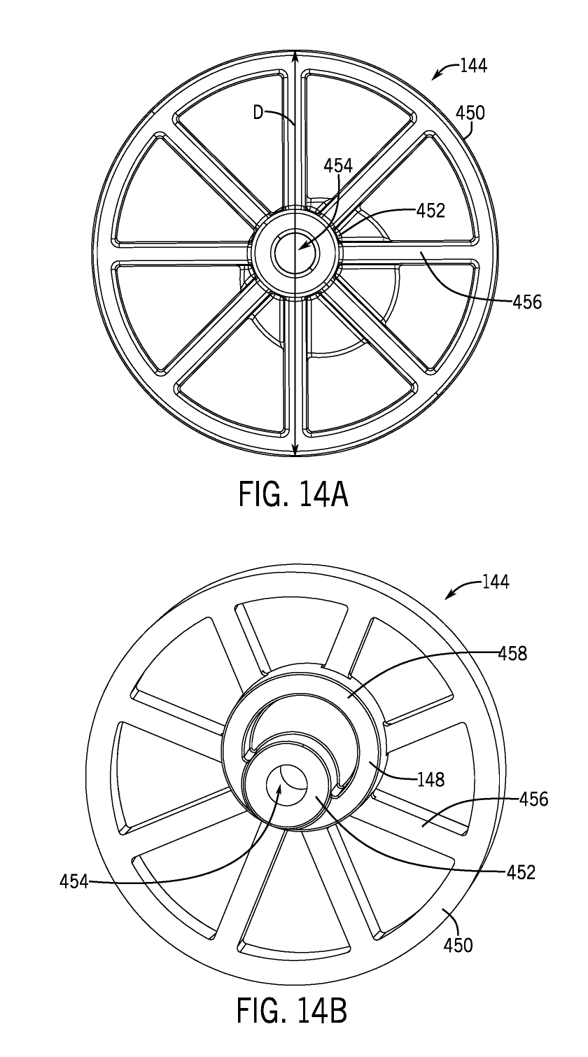

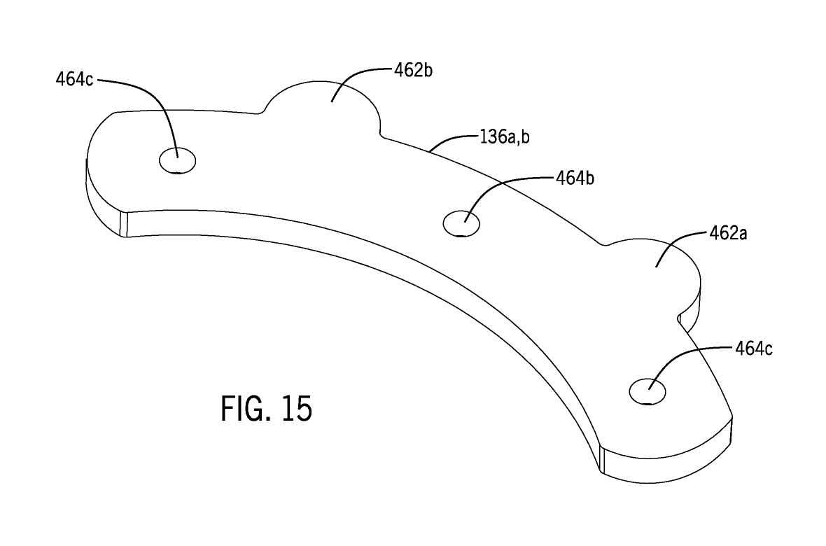

As briefly discussed above, in some embodiments, the showerhead 100 may include a mist feature. In these embodiments, the mist caps 136a, 136b are connected to the face plate 134. FIG. 15 illustrates one example of the mist caps 136a, 136b. The mist caps 136a, 136b may be formed as a generally curved bracket including two supporting nubs 462a, 462b that extend from one edge and a plurality of mist apertures 464a, 464b, 464c defined therethrough. The mist caps 136a, 136b can be configured in other manners and works with the face plate 134 to create a desired fluid pattern.

Assembly of the showerhead 100 will now be discussed in more detail. It should be noted that the below discussion is meant as exemplary only and many of the steps can be done in other orders, simultaneously, or omitted. In some embodiments, the engine 124 is first assembled and can then be connected to the housing 116 as a unit. With reference to FIG. 8, to assemble the engine 124, the jet plate 132 is aligned with and connected to the mounting plate 130. The respective mode walls are aligned with the corresponding walls on the opposite plate. For example, the fourth mode wall 242 of the jet plate 132 is aligned with and engages the fourth mode wall 200 of the mounting plate 130; the third mode wall 240 aligns with and engages the third mode wall 198 of the mounting plate 130; the second mode wall 238 of the jet plate 132 aligns with and engages the second mode wall 196 of the mounting plate; and the first mode wall 236 of the jet plate 132 aligns with an engages the first mode wall 202 of the mounting plate 130. In this manner, the discrete mode flow pathways are defined by the combination of the channels defined by the mounting plate 130 and jet plate 132 mode walls. Specifically, the massage channels 208, 234 of the two plates 130, 132 combine to define a massage entry chamber 270, a first mode chamber 480 is defined by the two first mode channels 202, 244, a second mode chamber 482 defined by the second mode channels 204, 246, and a third mode chamber 484 is defined by the third mode channels 206, 248.

Each of the mode chambers 470, 480, 482, 484 are in fluid communication with a respective mode aperture 176a, 176b, 176c, 176d in the mounting plate 130 and the first mode chamber 480 is in fluid communication with the trickle mode aperture 210 as well as the first mode aperture 176b. However, in other embodiments, other mode chambers may be configured to be in fluid communication with the first mode aperture 176b.

With reference to FIGS. 9 and 12A-12C, the massage assembly 138 is then assembled and connected to the jet plate 132 and the face plate 134. In particular, securing shaft 142 is received within the pin recess 454 of the drive element 144 and the shutter 146 is connected to the cam 148. Specifically, the cam 148 is received in the cam aperture 420 of the shutter 146 with the cam surface 458 engaging the sidewalls 406a, 406b. As shown in FIG. 12C, once assembled, the shutter 146 length L extends past the outer perimeter of the rim 450 on both sides of the drive element 144. This is due to the length L of the shutter 146 being longer than the diameter of the outer rim 450.

With reference to FIGS. 8 and 11A, the massage assembly 138 is connected to the face plate 134. The securing shaft 142 is positioned within the pin aperture 346 defined in the pin structure 330 of the face plate 134. The shutter 146 is positioned within the massage chamber 320 and the engagement edges 412a, 412b of the shutter 146 are positioned adjacent to and engage with the restraining shelves 350a, 350b and restraining segments 336a, 336b of the massage wall 312. The bumper edges 414a, 414b are positioned adjacent to the end walls 332a, 332b of the massage wall 312. Depending on the position of the shutter 146, one of the bumper edges 414a, 414b will engage with one of the end walls 332a, 332b (as will be discussed below, as the shutter 146 changes position, the other of the bumper edges 414a, 414b will engage with the other of the end walls 332a, 332b).

The face plate 134 and massage assembly 138 will then be connected to the bottom of the jet plate 132. With reference to FIGS. 8, 11A, and 10B, the top end of the securing shaft 142 is received within the pin recess 276 defined on the jet plate 132. The massage wall 270 of the jet plate 132 is aligned with and engages the corresponding massage wall 312 of the face plate 132. The end walls 332a, 332b of the face plate 134 engage with the corresponding end walls 272a, 272b of the jet plate 132 with the middle sections of the sidewalls 334a, 334b, 274a, 274b being aligned as well to define a massage chamber 472 therebetween with the massage assembly 138 being received within the chamber 472.

The various mode walls are then aligned between the two plates 132, 134 as described above with respect to the connection between the mounting plate 130 and the jet plate 132 to define the different mode chambers. However, in addition to the first through the fourth walls being connected together, the outer wall 264 of the jet plate 132 is connected to and engages the outer wall 302 of the face plate 134. The combination of the jet plate 132 and the face plate 134 defines a first mode chamber 486 in fluid communicating with the first mode chamber 480 through the first mode apertures 256 of the jet plate 132, a second mode chamber 488 in fluid communication with the second mode chamber 482 through the second mode apertures 254 of the jet plate 132; and a third mode chamber 490 in fluid communication with the third mode chamber 484 through the apertures 252 of the jet plate 132. The massage chamber 472 is fluid communication with the massage entry chamber 470 through the jets 260a, 260b, 260c and the massage disrupter jets 262.

The various plates 130, 132, 134 of the engine 124 are secured together in a variety of manners, such as ultrasonic welding, adhesive, press fit, or the like. Once connected, the nozzle boot 140 is connected to the outer surface of the face plate 134 and is positioned over the various nozzles defined by the face plate 134.

With reference to FIGS. 4 and 5, after the engine 124 is connected together, the mode selector assembly 500 is connected to the back cover 160. The mode selector assembly 500 seals around the perimeter of one or more mode apertures of the mounting plate 130 to direct fluid into a specific mode aperture (or multiple mode apertures) and may include a seal 506 and a spring 504. The mode selector assembly 500 is received within a compartment in the back cover 160. Additionally, the showerhead 100 may include a feedback assembly 502 that includes a biasing element 508 and a detent 510. The detent 510 is configured to be positioned in one of the detent recesses 174a, 174b, 174c, 174d, 174d, 174e, 174g on the mounting plate 130 to hold the showerhead in a particular mode, as well as to provide a sound and/or haptic feel to the user as the user rotates the mode selector 112 to select different modes.

Once the mode selector assembly 500 and the feedback assembly 502 are connected to the back cover 160, the back cover 160 is positioned within the housing 116. The mode selector 112 is then connected to the back cover 160 and configured to rotate the back cover 160, moving the mode selector assembly 500 and the feedback assembly 502, to different locations relative to the mounting plate 130 as discussed in more detail below. The engine 124 is connected to the back wall of the housing 116 by the engine connection assembly 126, which in turn secures the back cover 160 within the housing 116. The engine connection assembly 126 may include a fastener that is received within the fastening aperture 184 defined in the shaft 182 of the mounting plate 130 of the engine 124 and secures the engine 124 to the housing 116. As discussed in U.S. application Ser. No. 14/304,495 entitled “Showerhead with Turbine Driven Shutter,” filed Jun. 13, 2014 and incorporated by reference herein in its entirety, the engine connection assembly 126 allows the engine 124 to be easily and quickly replaced.

With reference to FIG. 4, the flow regulator 118 and filter 121 are connected to the connector 114 and received whiten the bottom end of the handle 103. The showerhead 100 is then fluidly coupled to a fluid source, such as a hose, tube, or J-pipe.

### Operation of the Showerhead

With reference to FIG. 3, when water is delivered to the handle 103, the water flows into the flow regular 118 and filter 120 and flows into the handle passageway 120. From the handle passageway 120, the water is directed into the inlet lumen 188 of the mounting plate 130 and flows around the shaft 182 and out of the plate outlet 190. As the water exits out of the plate outlet 190, the water is directed into a cavity defined in the back cover 160 that includes the mode selector assembly 500. The water flows through the seal 506 into one or more of the mode apertures 176a, 176b, 176c, 176d of the mounting plate 130. The mode selected depends on the orientation of the mode selector assembly 500 relative to the top surface 170 of the mounting plate 130 and can be varied by rotating the mode selector 112, which in turn rotates the back cover 160 and the mode selector assembly 500 which is connected thereto, correspondingly.

The feedback assembly 502 engages the top surface 170 of the mounting plate 130 and the detent 510 is inserted into one of the detent recesses 174a-174g corresponding to a particular mode, with the biasing element 508 biasing the detent 510 towards the mounting plate 130.

With reference to FIGS. 4, 5, and 8, when the first mode is selected, the first mode aperture 176a is fluidly connected to the plate outlet 190 and water flows therethrough. The water then flows into the first mode chamber 480 and through the first mode flow apertures 256 in the jet plate 132 into the first mode chamber 486 between the jet plate 132 and the face plate 134 and around the mist cap 460 into the first mode apertures 324. With reference to FIG. 3, the first mode apertures 324 define the first nozzle group 104 on the spray face 102 and the water is dispelled from those nozzles 104. In embodiments where the first mode corresponds to a mist mode, the water is dispelled in fine droplets, but in other embodiments may be dispelled in other manners.

When the trickle mode is selected, the mode selector assembly 500 is aligned with the trickle mode aperture 210 defined in the mounting plate 130. The fluid then follows the same path as described with respect to the first mode, but due to the decreased diameter of the trickle mode aperture 210 with respect to the first mode aperture 176a, the flow volume is significantly reduced, if not completely eliminated.

With reference again to FIGS. 4, 5, and 8, when the second mode is selected, the mode selector assembly 500 is aligned with the second mode apertures 176b in the mounting plate 130. The water then flows through the second mode aperture 176b into the second mode chamber 482 defined between the mounting plate 130 and the jet plate 132. The water enters the second mode chamber 488 defined between the jet plate 132 and the face plate 134 through the second mode apertures 254 in the jet plate 132. From the second mode chamber 488, the water exits the spray head 102 through the second mode apertures 322 in the face plate 134, which define the second nozzle group 106.

When the third mode is selected, the mode selector assembly 500 is aligned with the third mode apertures 176c and the water is directed into the third mode chamber 484 defined between the mounting plate 130 and the jet plate 132. From the third mode chamber 484, the water flows through the third mode apertures 252 in the jet plate 132 into the third mode chamber 490 defined between the jet plate 132 and the face plate 134. From the third mode chamber 490, the water exits the spray head 102 out of the third mode apertures 306 that define the third mode nozzle group 108.

When the massage mode is selected, the mode selector 500 is aligned with the mode aperture 176d. The water flows through the massage mode aperture 176d in the mounting plate 130 into the massage entry chamber 470. The water is directed to the jets 260a, 260b, 260c with a small amount of water flowing directly through the disrupter jets 262. The disrupter jets 262 reduce the fluid impacting the turbine, to reduce the speed of the turbine and create a desired massage pulse. By siphoning fluid through these jets 262, the output massage pulse may be slower and distinct. However, in instances where a faster pulse is desired, the jets 262 can be omitted. In some embodiments, the turbine rotates at approximately 1200 rotations per minute (rpm), which is considerably slower than conventional massage mode turbines. The slower rotational speed provides a more distinct massage pulse as the pulses are longer than in conventional showerheads.

The diameter of the disrupter jets 262 is selected to reduce the rotational speed of the turbine. In some embodiments, the diameter may be based primarily on an inlet to outlet ratio. Specifically, the jet diameters should be sized large enough to allow sufficient flow, but small enough to create a desired impingement force. In short, a balance between allow the flow to be sufficiently high to allow a desired flow pattern without flooding the massage chamber and without causing the turbine to stall during rotation.

From the jets 260, 260b, 260c, the water flows through the jet plate 132 and is angled towards the blades 456 of the drive element 144. This causes the drive element 144 to rotate about the securing shaft 142, causing the cam 148 to rotate, causing the cam surface 458 to move the shutter 146 between first and second positions. The cam surface 458 rotates within the cam aperture 402 and interfaces against the walls 404a, 404b, 406a, 406b defining the cam aperture 402 and due to the oblong shape of the cam aperture 402, causes the shutter 146 to oscillate side to side.

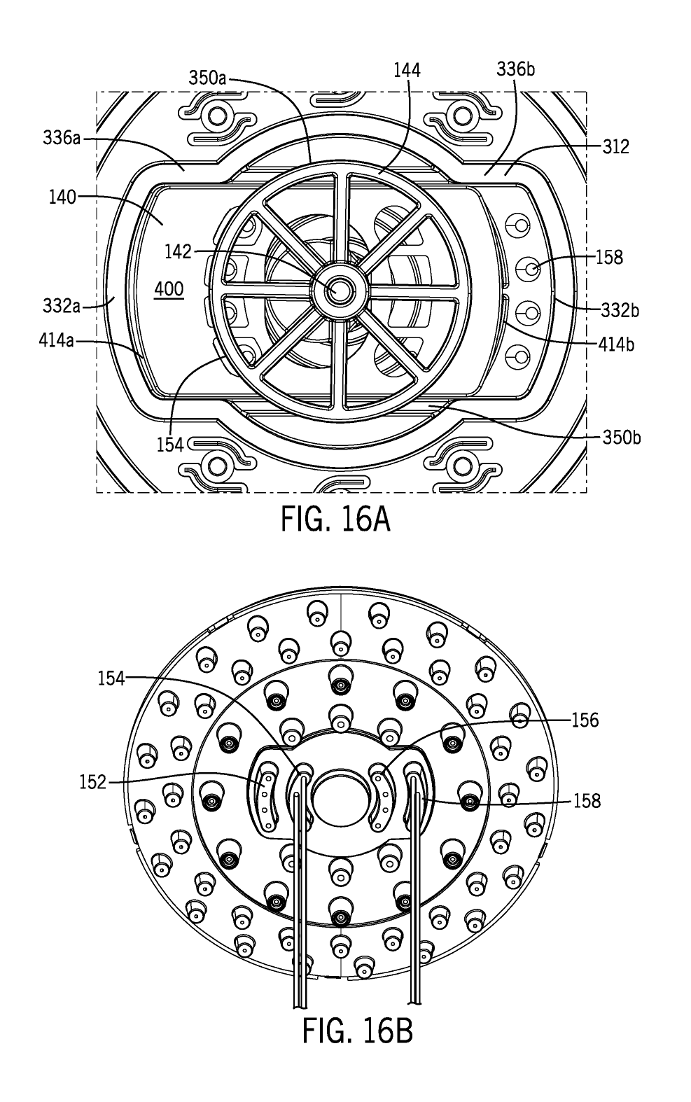

FIGS. 16A and 16B illustrate the showerhead in the massage mode with the shutter 146 in the first position. With reference to FIG. 16A, in the first position, the bumper edge 414a of the shutter 146 abuts against and may engage the bumper end wall 332a. In this position, the body 400 of the shutter 146 covers the first nozzle bank 152 and the first set of flow apertures 408a, 408b, 408c, 408d are positioned over the second nozzle bank 154, fluidly connecting the second nozzle bank 154 with the massage chamber 472, causing fluid to be expelled from the nozzles in the second nozzle bank 154. Simultaneously, the second end of 414b of the shutter 146 is spaced apart from the second end wall 332b of the massage wall 312 defined by the face plate 134. The gap uncovers the fourth nozzle bank 158, fluidly connecting the nozzles in the fourth nozzle bank 158 with the massage chamber 472. The third nozzle bank 156, however, is covered by the body 400 of the shutter 146 and is not in fluid communication with the massage chamber 472. In other words, the shutter 146 defines two flow paths between the inlet and the face plate of the showerhead, one that extends around an outer or terminal edge of the shutter and one that extends through the shutter (e.g., through the flow apertures).

With reference to FIG. 16B, in the first position, the second and fourth nozzle banks 154, 158 are open at the same time and the first and third nozzle banks 152, 156 are closed at the same time. This allows the water to be expelled in pulses from either side of the central region 161 and drive element 144 of the showerhead 100 at the same time.

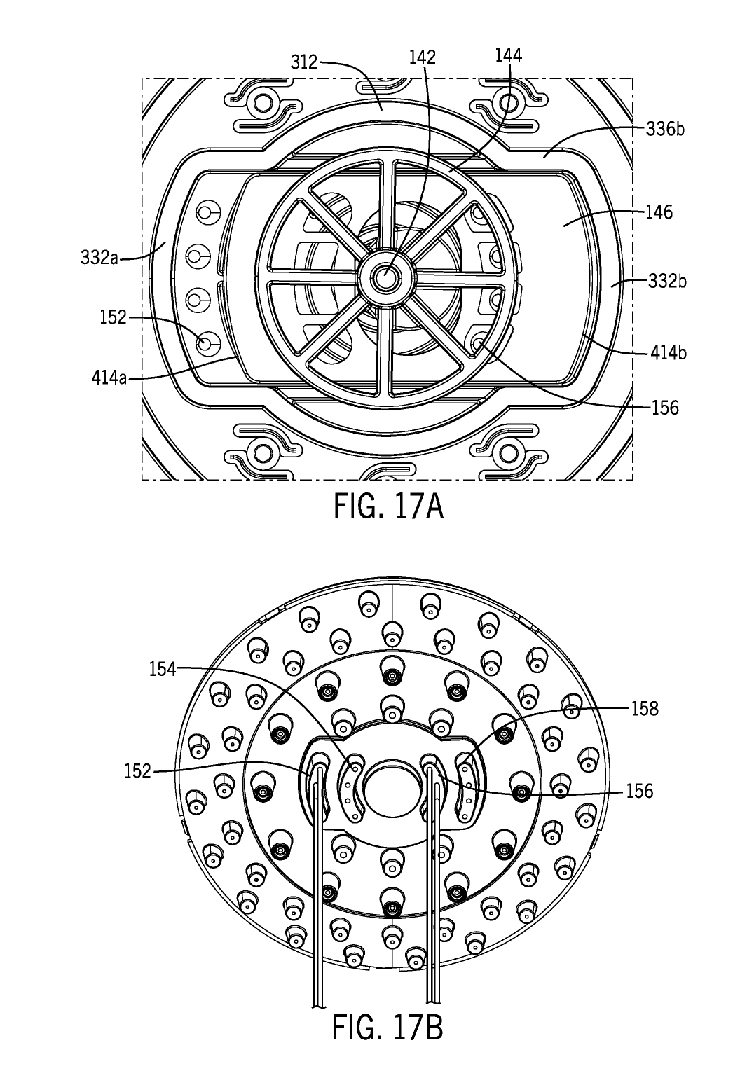

As the drive element 144 continues to rotate due to the water emitted from the jets 260a, 260b, 260c, the cam 148 rotates in the R direction (see FIG. 16A), moving the shutter 146 from the first position in FIG. 16A to the second position shown in FIG. 17A. In particular, the cam 148 causes the shutter 146 to move along the track 270 with the restraining walls 336a, 336c constraining the movement of the shutter 146 such that the shutter 146 moves in a substantially linear motion within the track, despite the rotational movement of the drive element. In the second position, the body of the shutter 146 blocks the second and fourth nozzle banks 154, 158 and fluidly connects the first and third nozzle banks 152, 156 to the massage chamber 472. Thus fluid is expelled from the first and third nozzle banks 152, 156. Similarly to the first position, in this second position of the shutter, two flow paths are defined between the inlet and the face plate, one around the edge of the shutter and one through the shutter.

In some embodiments, the water flow through each nozzle aperture in a particular nozzle bank starts and stops substantially simultaneously. This creates a more forceful effect as compared to conventional massage modes. Also, due to the shutter configuration, nozzles on either side of a central axis of the drive element are actuated simultaneously, delivering the massage pulse to different sections of a user's body simultaneously.

FIG. 19 illustrates another embodiment of the showerhead. With reference to FIG. 19, in this embodiment, a showerhead 650 may include a faceplate 634 supporting two massage assemblies 638a, 638b. In this embodiment, each of the massage assemblies 638a, 638b may be substantially similar to one another, but in other embodiments may have different features, such as different nozzle outlet configurations, different spin ratios, or the like. The dual massage assemblies 638a, 638b may be driven by a single turbine or multiple turbines and may be positioned in any one of the different spray pattern locations on the faceplate 634. In operation, when flow enters into the massage mode faceplate area, both massage assemblies 638a, 638b are activated, generating a dual force massage stream for a user.

It is noted that although FIG. 19 illustrates the two massage mode assemblies 638a, 638b positioned parallel to one another, in other embodiments, the massage mode assemblies 638a, 638b may be positioned perpendicular to one another or at other orientations as desired. Similarly, the shutters 146 for each of the massage mode assemblies 638a, 638b may be synchronized to match or counter the movement of the opposite shutter in order to generate a desired spray pattern. For example, the shutters movements may be paired, sequential, offset, or the like.

### Conclusion

It should be noted that although the various examples discussed herein have been discussed with respect to showerheads, the devices and techniques may be applied in a variety of applications, such as, but not limited to, sink faucets, kitchen and bath accessories, lavages for debridement of wounds, pressure washers that rely on pulsation for cleaning, care washes, lawn sprinklers, and/or toys.

All directional references (e.g., upper, lower, upward, downward, left, right, leftward, rightward, top, bottom, above, below, vertical, horizontal, clockwise, and counterclockwise) are only used for identification purposes to aid the reader's understanding of the examples of the invention, and do not create limitations, particularly as to the position, orientation, or use of the invention unless specifically set forth in the claims. Joinder references (e.g., attached, coupled, connected, joined and the like) are to be construed broadly and may include intermediate members between the connection of elements and relative movement between elements. As such, joinder references do not necessarily infer that two elements are directly connected and in fixed relation to each other.

In some instances, components are described by reference to “ends” having a particular characteristic and/or being connected with another part. However, those skilled in the art will recognize that the present invention is not limited to components which terminate immediately beyond their point of connection with other parts. Thus the term “end” should be broadly interpreted, in a manner that includes areas adjacent rearward, forward of or otherwise near the terminus of a particular element, link, component, part, member or the like. In methodologies directly or indirectly set forth herein, various steps and operations are described in one possible order of operation but those skilled in the art will recognize the steps and operation may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A massage mode assembly for a showerhead comprising:
a drive element having a drive element length, wherein the drive element is rotatable by fluid around an axis;
a cam connected to the drive element and rotatable therewith; and
a shutter operably connected to the cam, wherein the shutter has a shutter length that is longer than the drive element length and rotation of the cam causes the shutter to move correspondingly.

2. The massage mode assembly of claim 1, wherein the shutter comprises:
a cam aperture defined through a central region thereof, wherein the cam is received into the cam aperture; and
a plurality of flow apertures spaced about the cam aperture.

3. The massage mode assembly of claim 2, wherein the plurality of flow apertures comprise:
a first group of flow apertures positioned on a first side of the cam aperture; and
a second group of flow apertures positioned on a second side of the cam aperture.

4. The massage mode assembly of claim 2, wherein the plurality of flow apertures are distributed in an arc around the cam aperture.

5. The massage mode assembly of claim 1, further comprising a track, wherein the shutter is at least partially received within the track and the track constrains movement of the shutter in one direction.

6. The massage mode assembly of claim 1, wherein the drive element is a turbine.

7. A showerhead comprising:
a housing having an inlet in fluid communication with a fluid source; and
an engine received within the housing and in fluid communication with the fluid source, the engine comprising:
a turbine;
a cam extending from the turbine;
a shutter operably connected to the cam;
a first plate in fluid communication with the inlet; and
a second plate in fluid communication with the inlet, the second plate comprising:
a first group of outlet nozzles;
a second group of outlet nozzles;
a third group of outlet nozzles;
a fourth group of outlet nozzles; and wherein
the turbine rotates as fluid flows from the inlet into the engine;
as the turbine rotates, the cam rotates, moving the shutter correspondingly between a first position and a second position;
in the first position of the shutter, the first group of outlet nozzles and third group of outlet nozzles are fluidly disconnected from the fluid inlet and the second group of outlet nozzles and fourth group of outlet nozzles are fluidly connected to the fluid inlet; and
in the second position of the shutter, the second group of outlet nozzles and the fourth group of outlet nozzles are fluidly disconnected from the fluid inlet and the first group of outlet nozzles and the third group of outlet nozzles are fluidly connected to the fluid inlet.

8. The showerhead of claim 7, wherein the shutter defines a first flow aperture and a second flow aperture, wherein in the first position the first flow aperture is aligned with second group of outlet nozzles and in the second position the second flow aperture is aligned with the third group of outlet nozzles.

9. The showerhead of claim 8, wherein the second group of outlet nozzles are the only nozzles in selective fluidly communication with the first flow aperture and the third group of outlet nozzles are the only nozzles in selectively communication with the second flow aperture.

10. The showerhead of claim 8, wherein the first flow aperture is defined on a first side of the shutter and the second flow aperture is defined on a second side of the shutter.

11. The showerhead of claim 8, wherein the first flow aperture comprises a plurality of apertures and the second flow aperture comprises a plurality of apertures.

12. The showerhead of claim 11, wherein the first flow apertures are arranged in an arc and the second flow apertures are arranged in an arc.

13. The showerhead of claim 12, wherein the shutter further comprises a cam aperture for receiving the cam, wherein the first flow apertures are positioned around a first side of the cam aperture and the second flow apertures are positioned around a second side of the cam.

14. The showerhead of claim 7, wherein the second plate further comprises a track extending from a bottom surface of the second plate and surrounding the first group of outlet nozzles, the second group of outlet nozzles, the third group of outlet nozzles, and the fourth group of outlet nozzles, wherein the shutter is positioned within the track and the track constrains movement of the shutter in at least one direction.

15. The showerhead of claim 14, wherein the track defines a substantially linear movement path for the shutter as the shutter moves from the first position to the second position.

16. The showerhead of claim 7, wherein the shutter extends past the edges of the turbine.

17. A showerhead comprising:
a housing having an inlet;
a faceplate connected to the housing and defining a plurality of nozzles; and
a massage mode assembly received within the housing and in fluid communication with the inlet and the plurality of nozzles, the massage mode assembly comprising:
a turbine;
a cam connected to the turbine, wherein rotation of the turbine causes rotation of the cam; and
a shutter engaged with the cam such that rotation of the cam causes the shutter to move and as the shutter moves one or more edge flow paths around one or more outer edges of the shutter are defined and one or more aperture flow paths through one or more flow apertures in the shutter are defined.

18. The showerhead of claim 17, wherein the shutter moves between a first position and a second position and in the first position, a first edge flow path and a first aperture flow path are defined and in the second position a second edge flow path and a second aperture flow path are defined.
